(19) United States
(12) Patent Application Publication
(10) Pub. No.: US 2004/0014860 A1
(43) Pub. Date: Jan. 22, 2004

(54) Chemically reactive adhesive comprising at least one micro encapsulated component

(76) Inventors: Frank Meier, Duesseldorf (DE); Lothar Unger, Oberhausen (DE); Christian N. Kirsten, Burscheid (DE); Guenter Henke, Neuss (DE); Claudia Meckel-Jonas, Neuss (DE); Thorsten Schmidt, Langenfeld (DE)

Correspondence Address: HENKEL CORPORATION, THE TRIAD, SUITE 200, 2200 RENAISSANCE BLVD., GULPH MILLS, PA, 19406, US

(21) Appl. No.: 10/363,441

(22) PCT Filed: Aug. 28, 2001
(86) PCT No.: PCT/EP01/09871

(30) Foreign Application Priority Data
Sep. 1, 2000 (DE) 100 43 082.1

(51) Int. Cl. C08K 5/04; C08K 9/00; C08K 3/34

(52) U.S. Cl. 524/394; 156/272.2; 524/442; 523/216

(57) ABSTRACT

A reaction adhesive is provided. The reaction adhesive contains a reactive resin, an encapsulated curing agent for the resin and crystalline monoparticles with ferromagnetic, ferrimagnetic, superparamagnetic, prezoelectric or ferroelectric properties. The reaction adhesive is applied to the substrates and the substrates joined. The adhesive is subjected to an alternating electrical, magnetric or electromagnetic field to release the curing agent.

The invention relates to a reaction adhesive having at least one microencapsulated component comprising at least one resin, at least one curing agent, and at least one additive, and also to its preparation and use.

By reaction adhesives are meant adhesives which cure and set by way of chemical reactions (polymerizations, crosslinking) which can be initiated by heat, added curing agents or other components, or radiation (Rompp Lexikon Chemie—Version 2.0, Stuttgart/New York: Georg Thieme Verlag 1999).

Reaction adhesives having at least one micro-encapsulated component are known. WO 97/25360 describes, for example, a 1-component polyurethane adhesive which is composed essentially of a polyurethane prepolymer having terminal isocyanate groups and a microencapsulated curing component. A specific field of application for the reaction adhesive system described is specified as being the adhesive bonding of sheets of glass in the automobile industry. A specified advantage of the reaction adhesive system described is, for example, the attainment of faster “drive-away” times. By “drive-away” time is meant the period of time which allows, on the one hand, proper installation of the sheet of glass and, on the other hand, compliance with the material-quality and safety requirements.

The release of the microencapsulated curing agent and hence the activation of the curing reaction takes place, as described in more detail on page 19, paragraph 2, by destruction of the microcapsule. The destruction of the microcapsule may take place during the application of the reaction adhesive, by means of heat, shearing forces, ultrasound waves or microwaves. In one preferred embodiment the microcapsule is destroyed by shearing, the reaction adhesive being forced through a screen which at its narrowest point is narrower than the smallest microcapsules. In this version it is advantageous for this screen to possess long slits which with the wide apertures point in the direction of the reaction adhesive to be extruded while the narrower apertures point in the direction of the dispensing nozzle. The average particle size of the microcapsules lies between 10 to 2100 micrometers, preferably in the range from 1200 to 1200 micrometers.

A disadvantage of the system described is that the polymerization reaction is initiated as early as during the application procedure, i.e., within the applicator. Accordingly, for example, it is no longer possible to store temporarily a substrate coated with reaction adhesive. As a result of the initiation of the polymerization reaction within the applicator there exists the risk, furthermore, that part-cured or fully cured adhesive may clog the narrow apertures of the applicator. This can lead to production disruptions.

On the basis of this state of the art there arose the object of providing a reaction adhesive and a process which comprises at least one microencapsulated component which is released at any particular point in time in a manner which is as gentle as possible for adhesive and substrate. Naturally, the existing positive processing and service properties of the adhesive, especially high storage stability and good machine running properties during processing, should be retained as far as possible.

The inventive achievement of this object can be taken from the claims. It consists essentially in the provision of a reaction adhesive having at least one microencapsulated component comprising at least one resin, at least one curing agent, at least one additive, and nanoparticles with crystalline structures having ferromagnetic, ferrimagnetic, superparamagnetic or piezoelectric properties. The nanoparticles are present in the reaction adhesive in an order of magnitude from 0.02 to 5% by weight, preferably from 0.05 to 2% by weight, based on the overall composition of the reaction adhesive.

“Nanoparticles” for the purposes of the present invention are particles with crystalline structures having an average particle size (or an average particle diameter) of not more than 200 nm, preferably not more than 50 nm and in particular not more than 30 nm. Preferably the nanoparticles for use in accordance with the invention have an average particle size in the range from 1 to 40 nm, more preferably between 3 and 30 nm. For exploitation of the effects due to superparamagnetism the particle sizes ought not to be more than 30 nm. This particle size or crystallite size is determined preferably by the UPA (ultrafine particle analyzer) method; for example, by the laser light backscattering method. In order to avoid or prevent agglomeration or concretion of the nanoparticles, they are normally surface-modified or surface-coated. A process of this kind for preparing agglomerate-free nanoparticles is specified for iron oxide particles, as an example, in DE-A-196 14 136 in columns 8 to 10. A number of possibilities for the superficial coating of such nanoparticles to prevent agglomeration are specified in DE-A-197 26 282.

PCT/EP99/09303 describes the use of paramagnetic or ferromagnetic nanoparticles in adhesives. The advantage of such use lies in the better homogeneous distribution of the magnetic nanoparticles in the adhesive matrix. In the reprocessing of waste paper, for example, this helps to separate paper contaminated with adhesive residues by application of a magnetic field.

The nanoparticles described in PCT/EP99/09303 are explicitly incorporated to become part of the subject matter of the present application.

The nanoparticles comprise at least one element selected from the group consisting of Al, Fe, Co, Ni, Cr, Mo, W, V, Nb, Ta, Ce, Pr, Nd, Pm, Sm, Eu, Gd, Tb, Dy, Ho, Er, Tm, Yb, Lu, alloys of two or more of said elements, oxides of said elements or ferrites of said elements.

PCT/EP00/04453 (unpublished) relates to adhesive compositions whose binder system comprises nanoparticles having ferromagnetic, ferrimagnetic, superparamagnetic or piezoelectric properties.

The nanoparticles serve as “signal receivers” of electrical, magnetic or electromagnetic alternating fields and under the influence of these fields heating the adhesive layer in which they are located. The purpose of this heating of the adhesive layer is to part the adhesive bonds.

The nanoparticles described in PCT/EP00/04453, and the method of parting adhesive bonds using electrical, magnetic or electromagnetic alternating fields, are explicitly incorporated to become part of the subject matter of the present application.

The present invention therefore additionally provides for the use of the reaction adhesive of the invention for releasing microencapsulated reaction adhesive components, the adhesive being activated following release of at least one microencapsulated reaction adhesive component by the action of electrical, magnetic and/or electromagnetic alternating fields in combination where appropriate with pressure ultrasound and/or temperature and in the presence of nanoparticles.

For this purpose the reaction adhesive comprises nanoparticles which under the influence of these alternating fields allow the necessary permeability of the microcapsules for the emergence of the microencapsulated components. The nanoparticles may either be a direct constituent of the microcapsule or else located outside the microcapsule as a constituent of the adhesive formulation.

The nanoparticles serve as a reaction adhesive component having a “signal receiver” property, so that energy in the form of electromagnetic alternating fields is carried specifically into the reaction adhesive and in particular into the microcapsule. Through the introduction of energy there is a strong local temperature increase, which directly or indirectly makes it possible for the microcapsule shell to melt, swell or rupture. Direct in this context means that the nanoparticles are in or on the microcapsule shell and influence the constituents of the microcapsule shell directly by thermal interaction. Indirectly in this context means that the nanoparticles are located within the microcapsule, interact thermally therein with one another and/or where appropriate, with further constituents of the capsule contents, bring about swelling or melting of the capsule contents, and so induce the rupture of the microcapsule shell.

In comparison with the conventional methods of heating, a feature of the process of the invention is that the generation of heat takes place in a locally defined manner within the reaction adhesive and that a thermal load on the substrate materials to be bonded themselves is avoided or minimized. The process is greatly time-saving and effective, since the heat does not have to be introduced into the reaction adhesive layer by diffusion processes through the substrates to be bonded. This process also reduces considerably losses of heat by thermal conduction or thermal radiation via the substrate, as a result of which the process of the invention is particularly economical. Electrical, magnetic and/or electromagnetic alternating fields are suitable for introducing the energy. Where electrical alternating fields are employed, suitable nanoparticles are those made of piezoelectric substances, e.g. quartz, tourmaline, barium titanate, lithium sulfate, potassium tartrate, sodium tartrate, potassium sodium tartrate, ethylenediamine tartrate, ferroelectrics of perovskite structure, and, in particular, lead zirconium titanate.

Where magnetic alternating fields are used, suitable nanoparticles include in principle all those made of ferrimagnetic, ferromagnetic or superparamagnetic substances, particularly the metals aluminum, cobalt, iron, nickel or their alloys and also metal oxides of the type of n-maghemite (γ-Fe₂O₃), n-magnetite (Fe₃O₄), ferrites of the general formula MeFe₂O₄, where Me stands for divalent metals from the group copper, zinc, cobalt, nickel, magnesium, calcium or cadmium.

Where magnetic alternating fields are used, particularly suitable nanoparticles are superparamagnetic nanoparticles, referred to as “single-domain particles”. In comparison to the paramagnetic particles known from the prior art, a feature of the nanoparticles is that such materials do not exhibit hysteresis. A consequence of this is that the dissipation of energy is not brought about by magnetic hysteresis losses; instead, the generation of heat can be attributed to a rotation or vibration of the particles that is induced during exposure to an electromagnetic alternating field, or rotational movement of the magnetic dipole moments of the magnetic particles in the surrounding matrix, and thus, ultimately, to mechanical friction losses. This leads to a particularly effective heating rate of the particles and of the matrix surrounding them.

The preparation of magnetite or maghemite nanoparticles can be achieved, for example, through the use of a microemulsion technology. In this case the disperse phase of a microemulsion is used to limit the size of the particles formed. In a W/O microemulsion, a metallic reagent is dissolved in the disperse aqueous phase. The reagent is then reacted in the disperse phase to form a precursor of the desired magnetic compound, which from then on already has the desired size in the nanometer range. Thereafter, a careful oxidation step is used to prepare the metal oxide, especially iron oxide in the form of magnetite or maghemite. A process of this kind is described in, for example, U.S. Pat. No. 5,695,901.

Besides the nanoparticles described, further components suitable for the reaction adhesive of the invention include in principle the known reaction adhesive components, as described in, for example, G. Habenicht, “Kleben: Grundlagen, Technologie, Anwendungen”, 3^{rd} Edition, 1997 in chapter 2.

Thus, for example, resins used comprise polymers of epoxides, polyisocyanates, cyanoacrylates, methacrylates, unsaturated polyesters, polyvinylformials, phenol-formaldehyde resins, urea-formaldehyde resins, melamine-formaldehyde resins, resorcinol-formaldehyde resins, polybenzimidazoles, silicones, silane-modified polymers; or a mixture of two or more thereof.

Use is also made of curing agents from the group of catalytically active compounds such as peroxides, hydrogen chloride and/or compounds which react in accordance with the mechanism of polyaddition, having amino, hydroxyl, epoxy, isocyanate functionalities, carboxylic anhydrides; or a mixture of two or more.

At least one additive from the group of the catalysts, antioxidants, stabilizers, dye pigments, fragrances, preservatives; or a mixture of two or more of these additives may be a constituent of the reaction adhesive of the invention.

One particular version of the reaction adhesive of the invention is a polyurethane reaction adhesive based on a polyurethane prepolymer. In the context of the present text a polyurethane prepolymer is a compound such as results, for example, from the reaction of a polyol component with at least one isocyanate having a functionality of at least two.

This reaction can take place without solvent or in a solvent, ethyl acetate, acetone or methyl ethyl ketone for example.

The term “polyurethane prepolymer” embraces not only compounds having a relatively low molecular weight, such as are formed, for example, from the reaction of a polyol with an excess of polyisocyanate; also embraced, however, are oligomeric or polymeric compounds.

Molecular weight figures based on polymeric compounds refer, unless otherwise indicated, to the numerical average of the molecular weight (Mₙ).

The polyurethane prepolymers used in the context of the present invention generally have a molecular weight of from 500 to 27,000, preferably from 700 to 15,000, more preferably from 700 to 8,000 g/mol.

Likewise embraced by the term “polyurethane prepolymers” are compounds as formed, for example, from the reaction of a trivalent or tetravalent polyol with a molar excess of diisocyanates, based on the polyol. In this case one molecule of the resultant compound bears two or more isocyanate groups.

Polyurethane prepolymers having isocyanate end groups have been known for a long time. They can be crosslinked or chain-extended with suitable curing agents—usually polyfunctional alcohols—in a simple way to form substances of high molecular weight.

To obtain polyurethane prepolymers having terminal isocyanate groups it is customary to react polyfunctional alcohols with an excess of poly-isocyanates, generally at least predominantly diisocyanates. In this case the molecular weight can be controlled at least approximately by way of the ratio of OH groups to isocyanate groups. While a ratio of OH groups to isocyanate groups of 1:1 or near to 1:1 often leads to hard, possibly brittle molecules with high molecular weights, it is the case with a ratio of approximately 2:1, for example, when using diisocyanates, that one diisocyanate molecule is attached on average to each OH group, so that in the course of the reaction, in the ideal case, there is no oligomerization or chain extension.

Polyurethane prepolymers are customarily prepared by reacting at least one polyisocyanate, preferably a diisocyanate, and at least one component having functional groups which are reactive toward isocyanate groups, generally a polyol component, which is preferably composed of diols. The polyol component may contain only one polyol, although it is also possible to use a mixture of two or more polyols as polyol component. By a polyol is meant a polyfunctional alcohol, i.e., a compound having more than one OH group in the molecule.

By “functional groups which are reactive toward isocyanate groups” are meant, in the context of the present text, functional groups which can react with isocyanate groups to form at least one covalent bond. Suitable reactive functional groups may be mono-functional in the sense of a reaction with isocyanates: OH groups or mercapto groups, for example. Alternatively, they may also be difunctional with respect to isocyanates: amino groups, for example. A molecule containing an amino group, accordingly, also has two functional groups which are reactive toward isocyanate groups. In this context it is unnecessary for a single molecule to have two separate functional groups that are reactive toward isocyanate groups. What is critical is that the molecule is able to connect with two isocyanate groups with the formation in each case of one covalent bond.

As the polyol component is possible to use a multiplicity of polyols. These are, for example, aliphatic alcohols having from 2 to 4 OH groups per molecule. The OH groups may be both primary and secondary. Examples of suitable aliphatic alcohols include ethylene glycol, propylene glycol, butane-1,4-diol, pentane-1,5-diol, hexane-1,6-diol, heptane-1,7-diol, octane-1,8-diol and their higher homologs or isomers such as result for the skilled worker from a stepwise extension of the hydrocarbon chain by one CH₂ group in each case or with the introduction of branches into the carbon chain. Likewise suitable are higher polyfunctional alcohols such as, for example, glycerol, trimethylolpropane, pentaerythritol and also oligomeric ethers of said substances with themselves or in a mixture of two or more of said ethers with one another.

As the polyol component it is additionally possible to use reaction products of low molecular weight polyfunctional alcohols with alkylene oxides, referred to as polyethers. The alkylene oxides have preferably 2 to 4 carbon atoms. Suitable examples are the reaction products of ethylene glycol, propylene glycol, the isomeric butanediols, hexanediols or 4,4′-dihydroxy-diphenylpropane with ethylene oxide, propylene oxide or butylene oxide, or with mixtures of two or more thereof. Also suitable, furthermore, are the reaction products of polyfunctional alcohols, such as glycerol, trimethylolethane or trimethylolpropane, pentaerythritol or sugar alcohols, or mixtures of two or more thereof, with the stated alkylene oxides to form polyether polyols. Particularly suitable polyether polyols are those having a molecular weight from about 100 to about 10,000, preferably from about 200 to about 5,000.

Likewise suitable as the polyol component are polyether polyols such as are formed, for example, from the polymerization of tetrahydrofuran.

The polyethers are reacted in a way which is known to the skilled worker, by reaction of the starting compound having a reactive hydrogen atom with alkylene oxides: for example, ethylene oxide, propylene oxide, butylene oxide, styrene oxide, tetrahydrofuran or epichlorohydrin or mixtures of two or more thereof.

Examples of suitable starting compounds are water, ethylene glycol, propylene 1,2-glycol or 1,3-glycol, butylene 1,4-glycol or 1,3-glycol, hexane-1,6-diol, octane-1,8-diol, neopentylglycol, 1,4-hydroxymethylcyclohexane, 2-methyl-1,3-propanediol, glycerol, trimethylolpropane, hexane-1,2,6-triol, butane-1,2,4-triol, trimethylolethane, pentaerythritol, mannitol, sorbitol, methylglycosides, sugars, phenol, isononylphenol, resorcinol, hydroquinone, 1,2,2- or 1,1,2-tris(hydroxyphenyl)ethane, ammonia, methylamine, ethylenediamine, tetra- or hexamethyleneamine, triethanolamine, aniline, phenylenediamine, 2,4- and 2,6-diaminotoluene and polyphenylpolymethylene-polyamines, such as are obtainable by aniline-formaldehyde condensation, or mixtures of two or more thereof.

Likewise suitable for use as the polyol component are polyethers which have been modified by vinyl polymers. Products of this kind are available, for example, by polymerizing styrenenitrile or acrylonitrile, or a mixture thereof, in the presence of polyethers.

Polyester polyols having a molecular weight of from about 200 to about 10,000 are likewise suitable as the polyol component. Thus, for example, it is possible to use polyester polyols formed by reacting low molecular weight alcohols, especially ethylene glycol, diethylene glycol, neopentyl glycol, hexanediol, butanediol, propylene glycol, glycerol or trimethylolpropane, with caprolactone. Likewise suitable as polyfunctional alcohols for preparing polyester polyols are 1,4-hydroxymethylcyclohexane, 2-methyl-1,3-propanediol, butane-1,2,4-triol, triethylene glycol, tetraethylene glycol, polyethylene glycol, dipropylene glycol, polypropylene glycol, dibutylene glycol and poly-butylene glycol.

Further suitable polyester polyols are preparable by polycondensation. For instance, difunctional and/or trifunctional alcohols can be condensed with a substoichiometric amount of dicarboxylic acids and/or tricarboxylic acids, or their reactive derivatives, to form polyester polyols. Examples of suitable dicarboxylic acids are adipic acid or succinic acid and their higher homologs having up to 16 carbon atoms, unsaturated dicarboxylic acids such as maleic acid or fumaric acid, furthermore, and also aromatic dicarboxylic acids, particularly the isomeric phthalic acids, such as phthalic acid, isophthalic acid or terephthalic acid. Examples of suitable tricarboxylic acids are citric acid or trimellitic acid. These acids may be used individually or as mixtures of two or more thereof. Particularly suitable in the context of the invention are polyester polyols formed from at least one of said dicarboxylic acids and glycerol which have a residual OH group content. Particularly suitable alcohols are hexanediol, ethylene glycol, diethylene glycol or neopentyl glycol or mixtures of two or more thereof. Particularly suitable acids are isophthalic acid or adipic acid or their mixture.

Polyester polyols of high molecular weight include, for example, the reaction products of polyfunctional alcohols, preferably difunctional alcohols (together where appropriate with small amounts of trifunctional alcohols) and polyfunctional carboxylic acids, preferably difunctional carboxylic acids. Instead of free polycarboxylic acids use may also be made (if possible) of the corresponding polycarboxylic anhydrides or corresponding polycarboxylic esters with alcohols having preferably 1 to 3 carbon atoms. The polycarboxylic acids may be aliphatic, cycloaliphatic, aromatic or heterocyclic or both. They may where appropriate be substituted, by alkyl groups, alkenyl groups, ether groups or halogens, for example. Examples of suitable polycarboxylic acids include succinic acid, adipic acid, suberic acid, azelaic acid, sebacic acid, phthalic acid, isophthalic acid, terephthalic acid, trimellitic acid, phthalic anhydride, tetrahydrophthalic anhydride, hexahydrophthalic anhydride, tetrachlorophthalic anhydride, endomethylenetetrahydrophthalic anhydride, glutaric anhydride, maleic acid, maleic anhydride, fumaric acid, dimer fatty acid or trimer fatty acid or mixtures of two or more thereof. Where appropriate, minor amounts of monofunctional fatty acids may be present in the reaction mixture.

The polyesters may where appropriate contain a small fraction of carboxyl end groups. Polyesters obtainable from lactones, ε-caprolactone for example, or hydroxycarboxylic acids, ω-hydroxycaproic acid for example, may likewise be used.

Polyacetals are likewise suitable as the polyol component. By polyacetals are meant compounds as obtainable from glycols, for example, diethylene glycol or hexanediol or the mixture thereof with formaldehyde. Polyacetals which can be used in the context of the invention may likewise be obtained by the polymerization of cyclic acetals.

Further suitable polyols are polycarbonates. Polycarbonates can be obtained, for example, by reacting diols, such as propylene glycol, butane-1,4-diol or hexan-1,6-diol, diethylene glycol, triethylene glycol or tetraethylene glycol, or mixtures of two or more thereof, with diaryl carbonates, for example, diphenyl carbonate, or phosgene.

Likewise suitable as polyol component are polyacrylates which carry OH groups. These polyacrylates are obtainable, for example, by polymerizing ethylenically unsaturated monomers which carry an OH group. Monomers of this kind are obtainable, for example, by esterifying ethylenically unsaturated carboxylic acids and difunctional alcohols, the alcohol generally being present in a slight excess. Examples of ethylenically unsaturated carboxylic acids suitable for this purpose are acrylic acid, methacrylic acid, crotonic acid or maleic acid. Corresponding esters carrying OH groups are, for example, 2-hydroxyethyl acrylate, 2-hydroxyethyl methacrylate, 2-hydroxypropyl acrylate, 2-hydroxypropyl acrylate, 2-hydroxypropyl methacrylate, 3-hydroxypropyl acrylate or 3-hydroxypropylmethacrylate or mixtures of two or more thereof.

Besides the diols of the polyol component diisocyanates are important building blocks of the polyurethane which can be used as a component of the reaction adhesive. These are compounds of the general structure O═C═N—X—N═C═O, where X is an aliphatic, alicyclic or aromatic radical, preferably an aliphatic or alicyclic radical having from 4 to 18 carbon atoms.

As suitable isocyanates mention may be made, for example of 1,5-naphthylene diisocyanate, 4,4′-diphenylmethane diisocyanate (MDI), hydrogenated MDI (H₁₂MDI), xylylene diisocyanate (XDI), tetramethylxylylene diisocyanate (TMXDI), 4,4′-diphenyldimethyl-methane diisocyanate, di- and tetraalkylene-diphenylmethane diisocyanate, 4,4′-dibenzyl diisocyanate, 1,3-phenylene diisocyanate, 1,4-phenylene diisocyanate, the isomers of tolylene diisocyanate (TDI), 1-methyl-2,4-diisocyanatocyclohexane, 1,6-diisocyanato-2,2,4-trimethylhexane, 1,6-diisocyanato-2,4,4-trimethylhexane, 1-isocyanatomethyl-3-isocyanato-1,5,5-trimethylcyclohexane (IPDI), chlorinated and brominated diisocyanates, phosphorus-containing diisocyanates, 4,4′-diisocyanatophenylperfluoroethane, tetramethoxybutane 1,4-diisocyanate, butane 1,4-diisocyanate, hexane 1,6-diisocyanate (HDI), dicyclohexylmethane diisocyanate, cyclohexane 1,4-diisocyanate, ethylene diisocyanate, bisisocyanatoethyl phthalate and also diisocyanates having reactive halogen atoms, such as 1-chloromethylphenyl 2,4-diisocyanate, 1-bromomethylphenyl 2,6-diisocyanate, 3,3-bischloromethyl ether 4,4′-diphenyl diisocyanate.

Sulfur-containing polyisocyanates are obtained, for example, by reacting 2 mol of hexamethylene diisocyanate with 1 mol of thiodiglycol or dihydroxydihexyl sulfide. Further diisocyanates which can be used are, for example, trimethylhexamethylene diisocyanate, 1,4-diisocyanatobutane, 1,12-diisocyanatododecane and dimer fatty acid diisocyanate. Particularly suitable are the following: tetramethylene, hexamethylene, undecane, dodecamethylene, 2,2,4-trimethylhexane, 1,3-cyclohexane, 1,4-cyclohexane, 1,3- or 1,4-tetramethylxylene, isophorone, 4,4-dicyclohexylmethane and lysine ester diisocyanates. Very particular preference is given to tetramethylxylylene diisocyanate (TMXDI), especially the m-TMXDI from Cyanamid.

Examples of suitable isocyanates having a functionality of at least three are the trimerization and oligomerization products of the polyisocyanates already mentioned above, such as are obtainable, with the formation of isocyanurate rings, by appropriate reaction of polyisocyanates, preferably of diisocyanates. Where oligomerization products are used, those particularly suitable have a degree of oligomerization of on average from about 3 to about 5. Isocyanates suitable for the preparation of trimers are the diisocyanates already mentioned above, particular preference being given to the trimerization products of the isocyanates HDI, MDI or IPDI.

Likewise suitable for use are the polymeric isocyanates, such as are obtained, for example, as a residue in the distillation bottoms in the distillation of diisocyanates. Particularly suitable in this context is the polymeric MDI as is obtainable from the distillation residue during the distillation of MDI.

The polyurethane prepolymers can be crosslinked or chain-extended with suitable curing agents, generally polyfunctional alcohols or amines, but also water, in a simple way to give substances of high molecular weight. For this purpose, prepolymers are first of all prepared with excess diisocyanate, and are then extended subsequently with generally short-chain polyfunctional alcohols and/or amines and/or water.

As curing agents, specific mention may be made of the following:

saturated and unsaturated glycols such as ethylene glycol or condensates of ethylene glycol, butane-1,3-diol, butane-1,4-diol, 2-butene-1,4-diol, 2-butyne-1,4-diol, propane-1,2-diol, propane-1,3-diol, neopentyl glycol, hexanediol, bishydroxymethylcyclohexane, dioxyethoxyhydroquinone, bisglycol terephthalate, N,N′-di(2-hydroxyethyl)-succinamide, N,N′-dimethyl-N,N′-di(2-hydroxyethyl)succinamide, 1,4-di(2-hydroxymethylmercapto)-2,3,5,6-tetrachlorobenzene, 2-methylenepropane-1,3-diol, 2-methylpropane-1,3-diol, 3-pyrrolidino-1,2-propanediol, 2-methylenepentane-2,4-diol, 3-alkoxy-1,2-propanediol, 2-ethylhexane-1,3-diol, 2,2-dimethylpropane-1,3-diol, 1,5-pentanediol, 2,5-dimethyl-2,5-hexanediol, 3-phenoxy-1,2-propanediol, 3-benzyloxy-1,2-propanediol, 2,3-dimethyl-2,3-butanediol, 3-(4-methoxyphenoxy)-1,2-propanediol, and hydroxymethylbenzyl alcohol;

aliphatic, cycloaliphatic, and aromatic diamines such as ethylenediamine, hexamethylenediamine, 1,4-cyclohexylenediamine, piperazine, N-methylpropylenediamine, diaminodiphenyl sulfone, diaminodiphenyl ether, diaminodiphenyldimethylmethane, 2,4-diamino-6-phenyltriazine, isophoronediamine, dimer fatty acid diamine, diaminodiphenylmethane, aminodiphenylamine or the isomers of phenylenediamine;

furthermore, also carbohydrazides or hydrazides of dicarboxylic acids;

amino alcohols such as ethanolamine, propanolamine, butanolamine, N-methylethanolamine, N-methylisopropanolamine, diethanolamine, triethanolamine, and higher di- or tri(alkanolamines);

aliphatic, cycloaliphatic, aromatic and heterocyclic mono- and diaminocarboxylic acids such as glycine, 1- and 2-alanine, 6-aminocaproic acid, 4-aminobutyric acid, the isomeric mono- and diaminobenzoic acids, and the isomeric mono- and diaminonaphthoic acids.

The cure time can be shortened by the presence of catalysts. Particularly suitable are tertiary amines, e.g.,triethylamine, triethanolamine, triisopropanolamine, 1,4-diazabicyclo[2.2.2]octane (=DABCO) dimethylbenzylamine, bisdimethylaminoethyl ether, and bismethylaminomethylphenol. Particularly suitable are 1-methylimidazole, 2-methyl-1-vinylimidazole, 1-allylimidazole, 1-phenylimidazole, 1,2,4,5-tetramethylimidazole,1-(3-minopropyl)imidazole, pyrimidazole, 4-dimethylaminopyridine, 4-pyrrolidinopyridine, 4-morpholinopyridine, 4-methylpyridine.

It is also possible to use organotin compounds as catalysts. These are compounds containing both tin and an organic radical, particularly compounds containing one or more Sn—C bonds. Organotin compounds in the wider sense include, for example, salts such as tin octoate and tin stearate. Tin compounds in the narrower sense include in particular compounds of tetravalent tin of the general formula Rₙ₊₁SnX₃₋ₙ, where n stands for a number from 0 to 2, R stands for an alkyl group or an aryl group or both, and X, finally, stands for an oxygen, sulfur or nitrogen compound or a mixture of two or more thereof. Advantageously, R contains at least 4 carbon atoms, in particular at least 8. The upper limit is situated generally at 12 carbon atoms. X is preferably an oxygen compound, i.e., an organotin oxide, hydroxide, carboxylate or an ester of an inorganic acid. However, X may also be a sulfur compound, i.e., an organotin sulfide, thiolate or a thio acid ester. Among the Sn-S compounds, thioglycolic esters are especially suitable, examples being compounds with the following radicals:

—S—CH₂—CH₂—CO—O—(CH₂)₁₀—CH₃ or

—S—CH₂—CH₂—CO—O—CH₂—CH (C₂H₅)—CH₂—CH₂—CH₂—CH₃.

A further preferred class of compound is represented by the dialkyltin(IV) carboxylates (X═O—CO—R¹). The carboxylic acids have 2, preferably at least 10, in particular 14 to 32 carbon atoms. It is also possible for dicarboxylic acids to be used. Examples of suitable acids include adipic acid, maleic acid, fumaric acid, terephthalic acid, phenylacetic acid, benzoic acid, acetic acid, propionic acid, and especially caprylic, capric, lauric, myristic, palmitic, and stearic acids. Particularly suitable are, for example, dibutyltin diacetate and dilaurate and also dioctyltin diacetate and dilaurate.

Additionally, tin oxides and tin sulfides, and also tin thiolates, are suitable in the context of the present invention. Specific compounds include the following: bis(tributyltin) oxide, dibutyltin didodecylthiolate, dioctyltin dioctylthiolate, dibutyltin bis(2-ethylhexyl thioglycolate), octyltin tris(2-ethylhexyl thioglycol-ate), dioctyltin bis(thioethylene glycol 2-ethylhexoate), dibutyltin bis(thioethylene glycol laurate), dibutyltin sulfide, dioctyltin sulfide, bis(tributyltin) sulfide, dibutyltin bis(2-ethylhexyl thioglycolate), dioctyltin bis(thioethylene glycol 2-ethylhexoate), trioctyltin thioethylene glycol 2-ethylhexoate, and also dioctyltin bis(2-ethylhexyl thiolatoacetate), bis(S,S-methoxycarbonylethyl)tin bis(2-ethylhexylthiolatoacetate), bis(S,S-acetylethyl)tin bis(2-ethylhexyl thiolatoacetate), tin(II) octylthiolate, and tin(II) thioethylene glycol 2-ethylhexoate.

Furthermore, mention may also be made of the following: dibutyltin diethylate, dihexyltin dihexylate, dibutyltin diacetylacetonate, dibutyltin diethylacetylacetate, bis(butyldichlorotin) oxide, bis(dibutylchlorotin) sulfide, tin(II) phenolate, tin(II) acetylacetonate, and also other α-dicarbonyl compounds such as acetylacetone, dibenzoylmethane, benzoylacetone, ethyl acetoacetate, n-propyl acetoacetate, ethyl α,α′-diphenylacetoacetate, and dehydroacetoacetic acid.

Where appropriate, in addition to a catalyst, the polyurethane composition of the invention may comprise further additives. The additives may account for a fraction of up to about 10% by weight of the overall composition.

The additives which can be used in the context of the present invention include catalysts, plasticizers, stabilizers, antioxidants, dyes, light stabilizers, fillers, dye pigments, fragrances, preservatives or mixtures thereof.

Plasticizers used are, for example, plasticizers based on phthalic acid, especially dialkyl phthalates, preferred plasticizers being phthalic esters esterified with a linear alkanol containing from about 6 to about 12 carbon atoms. Particular preference is given in this context to dioctyl phthalate.

Likewise suitable as plasticizers are benzoate plasticizers, examples being sucrose benzoate, diethylene glycol dibenzoate and/or diethylene glycol benzoate, in which about 50 to about 95% of all hydroxyl groups have been esterified, phosphate plasticizers, examples being t-butylphenyl diphenyl phosphate, polyethylene glycols and their derivatives, examples being diphenyl ethers of poly(ethylene glycol), liquid resin derivatives, an example being the methyl ester of hydrogenated resin, vegetable and animal oils, examples being glyceryl esters of fatty acids, and the polymerization products thereof.

The antioxidants or stabilizers which can be used as additives in the context of the invention include hindered phenols of high molecular weight (Mₙ) polyfunctional phenols, and sulfur- and phosphorus-containing phenols. Examples of phenols which can be used as additives in the context of the invention are 1,3-5-trimethyl-2,4,6-tris(3,5-di-tert-butyl-4-hydroxybenzyl)benzene; pentaerythritol tetrakis-3-(3,5-di-tert-butyl-4-hydroxyphenyl)propionate; n-octadecyl 3,5-di-tert-butyl-4-hydroxyphenyl)propionate; 4,4-methylenebis(2,6-di-tert-butylphenol); 4,4-thiobis(6-tert-butyl-o-cresol); 2,6-di-tert-butylphenol; 6-(4-hydroxyphenoxy)-2,4-bis(n-octylthio)-1,3,5-triazine; di-n-octadecyl 3,5-di-tert-butyl-4-hydroxybenzyl-phosphonates; 2-(n-octylthio)ethyl 3,5-di-tert-butyl-4-hydroxybenzoate; and sorbitol hexa[3-(3,5-di-tertbutyl-4-hydroxyphenyl)propionate].

Examples of suitable light stabilizers are those available commercially under the name TINUVIN® (manufacturer: Ciba Geigy).

The polyurethane prepolymer is prepared by a process known to the skilled worker, generally in the absence of moisture and under an inert gas atmosphere. For example, the polyol component, together where appropriate with a suitable solvent, is charged to a suitable vessel and mixed. Then, while mixing continues, the isocyanate component with a functionality of at least two is added. To accelerate the reaction it is common to raise the temperature to from 40° C. to 80° C. Generally, the exothermic reaction which ensues provides a further increase in temperature. The temperature of the batch is held at about 70° C. to 110° C. Where appropriate, to accelerate the reaction, catalysts customary in polyurethane chemistry, preferably dibutyltin dilaurate or diazabicyclooctane (DABCO), can be added. If the use of a catalyst is desired, it is added generally in an amount from about 0.005% by weight to about 0.5% by weight, based on the batch, to the reaction mixture. The reaction time depends on the nature and amount of the starting materials used, on the reaction temperature, and on any catalyst present. The total reaction time is normally from about 30 minutes to about 20 hours.

The curing agent which is part of the reactive adhesive system, and further additives where appropriate, are subjected in a microencapsulation process known to the skilled worker, for example, to coacervation, interfacial polymerization, spray drying, immersion or centrifuge methods, multifluid nozzles, fluidized bed, electrostatic microencapsulation, vacuum encapsulation, and are isolated. The microcapsules are preferably prepared by the spray drying process; in principle, all spray drying processes known to the skilled worker are suitable here. In a spray drying process the aqueous solution or dispersion comprising the constituents of the microcapsule are sprayed together with a hot air stream, with the aqueous phase or all the constituents which are volatile in the air stream evaporating.

The reaction adhesive components to be encapsulated can be prepared, for example, as described under U.S. Pat. No. 3,389,194. It is likewise possible to use techniques for microencapsulating magnetic particles and polymers for preparing the microcapsules as are described in more detail in WO 99/59556. The nanoparticles may be part of the microcapsule shell and/or may be located within the interior of the microcapsule.

In one particular embodiment of the invention further nanoparticles are added before the spray drying process. For example, 20%, preferably 10%, of nanoparticles, based on the mass of microcapsules, are added to the aqueous solution or dispersion comprising the constituents of the microcapsules. The subsequent spray drying process causes statistical incorporation of the nanoparticles in the microcapsule shell or external attachment thereof.

One preferred embodiment of the present invention is a reaction adhesive comprising microcapsules, where not only curing agents but also nanoparticles and, where appropriate, further components have been micro-encapsulated.

The microcapsules have the function of a latent curing system. To order—that is, by application of electrical, magnetic and/or electromagnetic alternating fields, in combination where appropriate with pressure, ultrasound and/or temperature—the nanoparticles first, selectively, warm up. Through energy transfer, the nanoparticles bring about melting, swelling or rupturing of the microcapsule shell to an extent such that curing agents and any further additives are released into the surrounding reaction adhesive matrix. As already described, the transfer of energy may take place directly to the constituents of the microcapsule shell, where it brings about melting, swelling or rupturing of the microcapsule shell. Also possible primarily is a transfer of energy of the nanoparticles to the microcapsule contents, as a result of which, for example, the microcapsule contents begin to swell and cause, for example, rupturing of the microcapsule shell.

As a result of the release of the curing agent and any further additives, preferably catalysts, the process of curing begins and continues through to the desired end properties of the adhesive.

The microcapsules have a particle size of from 100 nanometers to 800 micrometers, preferably from 0.1 to 100 micrometers, and more preferably from 0.5 to 60 micrometers. In another particular embodiment the microcapsules have a particle size of from 0.1 to 10 micrometers, particularly as a reaction adhesive component in laminating adhesives. The size and concentration of the microcapsules is made such that effective opening of the microcapsules can take place and a sufficient strength for the desired application is obtained after the adhesive is cured. However, the size and concentration of the microcapsule must also be such that the polymers which are used for encapsulation and which remain within the adhesive system do not exert any adverse effects on the adhesion and cohesion properties of the adhesive.

Polymers suitable for encapsulating the reaction adhesive components are those which are insoluble in the reaction adhesive component to be encapsulated. The polymers preferably have a melting point of 40° C. to 200° C. Additionally, the polymers preferably have film-forming properties. Examples of suitable polymers are the following: hydrocarbon waxes, wax esters, polyethylene waxes, oxidized hydrocarbon waxes containing hydroxyl or carboxyl groups, polyesters, polyamides, or mixtures of two or more thereof.

To prepare the microcapsule shell it is particularly preferred to use water-soluble or at least water-dispersible polymers, but especially natural or synthetic polyanions as set out by A. Prokop, D. Hunkeler et al. in Advances in Polymer Science, 136 (1998), in Table 2 on page 5-7.

The microcapsules are present within the reaction adhesive in an amount of from 0.2 to 20% by weight, preferably in an amount of from 0.2 to 10% by weight, based on the overall composition of the reaction adhesive.

In one preferred version the nanoparticles are part of the microcapsule. The fraction of the nanoparticles in the microcapsule is from 0.05 to 20% by weight, preferably from 0.05 to 10% by weight.

As well as nanoparticles, further reaction adhesive components may be part of the microcapsule. The total concentration of the reaction adhesive components in this case is from 1 to 90% by weight, preferably from 5 to 70% by weight, based on the overall weight of the microcapsule.

In another preferred embodiment nanoparticles and curing agent are part of the microcapsule. The concentration of the curing agent or curing agent mixture present in the microcapsule is between 1 to 90% by weight, preferably 50 to 80% by weight based on the overall weight of the microcapsule.

The microencapsulated nanoparticles and curing agent may be used in adhesives, sealants, coating materials, and moldings. For this purpose preferably solid curing agents are mixed with the corresponding nanoparticles in a weight proportion of from 0.5:1 to 20:1, preferably from 1:1 to 15:1 and more preferably from 5:1 to 12:1. The mixture is melted at temperatures of 60°-140°0 Celsius. The melt is introduced with stirring into organic solvents, preferably apolar organic solvents. Thereafter the resultant powder is separated from the solvent by means of a customary laboratory method and dried. The dried powder is comminuted by mechanical means, using mortars for example, to a particle size of 1-20μ, preferably 3-15μ, and more preferably 5-10μ. The resulting particle size and particle size distribution is determined by means of a light microscope. The comminuted powder is dispersed in water and adjusted where appropriate to a pH of 3-6. Preferably at room temperature, a solution or dispersion of the film-forming polymer is added to the dispersion and subsequently stirred. Following concentration, the aqueous solution or dispersion formed, which comprises the constituents of the microcapsules, is sprayed together with a hot air stream, with the aqueous phase or all the constituents which are volatile in the air stream evaporating.

The catalyst is preferably added to the curing agent. Its amount is governed by its activity and the reaction conditions. It is preferably in the range from 0.001 to 0.5% by weight, based on the curing agent.

The reaction adhesive of the invention contains

A) from 50 to 95% by weight of at least one NCO-terminated polyurethane prepolymer,

B) from 0.2 to 20% by weight of microcapsules comprising at least one curing agent and also nanoparticles having ferromagnetic, ferrimagnetic, superparamagnetic or piezoelectric properties,

C) from 0 to 20% by weight of at least one curing agent

D) from 0.05 to 30% by weight of additives based on the overall composition of the adhesive.

One particular embodiment is a reaction adhesive comprising:

A) at least one NCO-terminated polyester polyurethane,

B) microcapsules comprising at least one curing agent based on an aromatic diamine and also nanoparticles having ferromagnetic, ferrimagnetic, superparamagnetic or piezoelectric properties and

C) at least one curing agent from the group of the polyols.

The reaction adhesive can be formulated as what is called a 1-component (1-pack) adhesive. This means that microcapsules comprising the curing agent and, where appropriate, further reaction adhesive components are mixed with one another with the resin, consisting of the polyurethane prepolymer and, where appropriate, further reaction adhesive components, directly after preparation. Generally, these 1-pack adhesives still include solvents.

The reaction adhesive may also be prepared as what is called a 2-component (2-pack) adhesive. This means that microcapsules comprising the curing agent and, where appropriate, further reaction adhesive components are mixed with one another with the resin consisting of the polyurethane prepolymer and, where appropriate, further reaction adhesive components not until immediately before application. Mixing can take place, for example, in a static mixer and the mixture can be supplied via a metering system to the application system.

The reaction adhesive composition of the invention is preferably used as an adhesive for laminating and is distinguished in processing by high reactivity and short cure times.

The reaction adhesive composition of the invention possesses long storage times in respect of the mixture of the prepolymer component with microcapsules and their constituents, and also of the curing component with microcapsules and their constituents. Despite an abbreviated cure time, the pot life required for processing is retained or can be significantly prolonged. The pot life is understood, in accordance with DIN 16920, to be the period of time within which a batch of a reaction adhesive is usable for a particular use after all of the adhesive components have been mixed. The pot life depends on the composition of the reaction adhesive and on the external circumstances, such as, for example, the nature of the plant, the ambient temperature, the atmospheric humidity. Where the reaction adhesive composition of the invention still contains solvent, the pot lives is from eight to 30 hours. Where the reaction adhesive composition of the invention is free from solvent, the pot life is 0.5 to 30 hours.

The critical advantage in the use of the reaction adhesive of the invention lies in the activation of the bonding process at any, individually desirable point in time by release of at least one microencapsulated reaction adhesive component through the action of electrical, magnetic and/or electromagnetic alternating fields in combination where appropriate with pressure ultrasound and/or temperature and in the presence of nanoparticles.

Energy suitable for activating the nanoparticle-comprising reaction adhesives having at least one microencapsulated component includes in principle any relatively high-frequency electromagnetic alternating field: thus it is possible, for example, to use electromagnetic radiation from the so-called ISM (industrial, scientific and medical application) sectors; further details on this can be found, inter alia, in Kirk-Othmer, “Encyclopedia of Chemical Technology”, 3^{rd} Edition, Volume 15, Chapter on “Microwave Technology”.

To activate the nanoparticles it is even possible to use virtually any frequency in the very low-frequency range from about 50 kHz or 100 kHz up to 100 MHz in order to bring about melting, swelling or rupturing of the microcapsule. The frequency can be selected according to the available equipment, taking care of course to ensure that no interference fields are emitted.

The intention below is to illustrate the invention using a principle experiment, the selection of the example not being intended to constitute any restriction on the scope of the subject matter of the invention. It shows, merely in the manner of a model, the way in which the adhesive composition of the invention works.

### EXAMPLE

### I. Starting Materials for Preparing the Reaction Adhesives

1. Liofol UK 3640 (prepolymer based on MDI and polyester) from Henkel KGaA

2. Liofol UK 6000 (polyol-based curing agent) from Henkel KGaA

3. ADPA (aminodiphenylamine, curing agent) from Merck, Darmstadt

4. Bayferrox 318 M (magnetite, surface-modified nanoparticles (PAS)) from Bayer AG.

5. PSS (poly(sodium styrenesulfonate)) having a molar mass of about 70,000 or 1,000,000 g/mol from Aldrich

6. Mowiol 23-88 (polyvinyl alcohol) having a molar mass of about 150,000 g/mol from Clariant.

### II. Preparation of the Reaction Adhesives

1. Microencapsulation

Aminodiphenylamine is mixed with magnetite in a weight proportion of 9:1 and the mixture is melted in a drying cabinet at 100° C. The melt is introduced into cyclohexane with vigorous stirring. The powder which forms is separated from the cyclohexane by vacuum filtration and dried in the drying cabinet at 25° C. The dried powder is subsequently brought by mortaring and milling to a particle size of less than 10μ. The resulting particle size and distribution is determined by means of a light microscope.

22 g of the ground product are dispersed in 180 g of demineralized water, and 3.75 g of hydrochloric acid (32% strength by weight) are added.

The nanoparticles at this stage have an average size of about 30 nm, determined using an N4 Nanosizer. To the dispersion there is added at room temperature a solution of 6.65 g of poly(sodium styrenesulfonate) in 60 g of water, dropwise over a period of 2 hours, followed by stirring for 5 hours (yield: 98% of theoretical yield).

The dispersion is concentrated to a volume of 75 ml at 40° C., 60 ml of Mowiol 23-88 are added, 4% by weight based on the concentrated dispersion, and the dispersion is dried by spray drying.

2. Spray Drying

The spray drying parameters are chosen as follows: spray flow 800 1/h N2, aspirator output 20 arbitrary units, temperature entry: 145° C., temperature exit: 87° C. The microcapsules are obtained in yields of about 20-40% as a slightly colored product having a preferred particle size of 1-25μ. A subsequent sieving process gives particle sizes of 1 to 10 μ (sieve fractions: 100, 50, 25, 10, 5μ).

3. Reaction Adhesive

The sieved microcapsules are mixed with the polyol curing agent (Liofol UK 6000) in a weight amount ratio of 1:1. This mixture is subsequently mixed with the prepolymer Liofol UK 3640 in a weight amount ratio of 1:50.

4. Reference System

The following reference systems were chosen:

a) a mixture of Liofol UK 6000 with Liofol UK 3640 in a weight amount ratio of 1:50 and

b) a mixture in analogy to the process and stoichiometry of the system described in sections 1 to 3, with the exception that the microcapsules contain only aminodiphenylamine but no magnetite.

### III. Use of the Reaction Adhesives

The reaction adhesives described under (3.) and (4.) were used differently to carry out dry production of film composites (OPP/PE; OPP/OPP; OPA/PE; PET/PE) in a manual laminating process. The application weight for the respective composite was 4-8 g/m² or 2-3 g/m², depending on appropriate layer thickness.

The adhesive composites were subsequently brought into an electromagnetic alternating field. The adhesion of these samples 4 hours after lamination and irradiation were significantly increased as compared with the reference systems. Full cure or ultimate strength was attained much more quickly.

### IV. Measurement Methods and Apparatus

Particle Size Determination:

The particle size was determined using the “Microtac® UPA150” instrument from Honeywell and Sympatec Helos Vectra.

Spray Drying:

For spray drying the curing agent and the nanoparticle the “Mini-Spray B-191” apparatus from Buchi Labortechnik (Flawil, CH) was used.

Sieving:

For sieving the spray-dried microcapsules the “Model L3P Sonic Sifter Separator” apparatus from ATM Corporation (Milwaukee, USA) was used, fitted with a micro-precision sieve for particles having a diameter of 100 or 50, 25, 10 and 5μ.

Lamination:

Manual lamination was carried out using a doctor blade from RD Specialities Inc., Webster, N.Y., wire size 10 and 5μ.

Electromagnetic Alternating Field:

To generate the required magnetic alternating field an instrument from Hüttinger bearing the name “Hochfrequenzgenerator 1997, Type 1G 5/3000” was used, equipped with a 3-turn copper coil (D=5 mm). The frequency: was 1.8 MHz.

1. A reaction adhesive with at least one microencapsulated component comprising at least one resin, at least one curing agent, and at least one additive, characterized in that nanoparticles having crystalline structures with ferromagnetic, ferrimagnetic, superparamagnetic or piezoelectric properties are present.

2. The reaction adhesive of claim 1, characterized in that the average size of the nanoparticles is situated in the range from 1 to 200 nm.

3. The reaction adhesive of claim 1 or 2, characterized in that the nanoparticles comprise at least one element selected from the group consisting of Al, Fe, Co, Ni, Cr, Mo, W, V, Nb, Ta, Ce, Pr, Nd, Pm, Sm, Eu, Gd, Tb, Dy, Ho, Er, Tm, Yb, Lu, alloys of two or more of said elements, oxides of said elements or ferrites of said elements, preferably metal oxides of the type of n-maghemite (γ-Fe₂O₃), n-magnetite (Fe₃O₄) or the ferrites of the type of MeFe₂O₄ where Me is a divalent metal selected from manganese, copper, zinc, cobalt, nickel, magnesium, calcium, and cadmium.

4. The reaction adhesive of claim 1 or 2, characterized in that the nanoparticles are composed of piezoelectric substances selected from quartz, tourmaline, barium titanate, lithium sulfate, potassium tartrate, sodium tartrate, potassium sodium tartrate, ethylenediamine tartrate, ferroelectric compounds having perovskite structure or lead zirconium titanate.

5. The reaction adhesive of at least one of claims 1 to 4, characterized in that it comprises nanoparticles in an order of magnitude from 0.02 to 5% by weight, based on the overall composition of the reaction adhesive.

6. The reaction adhesive of claim 1, characterized in that as resin a polymer selected from the group consisting of epoxides, polyisocyanates and cyanoacrylates, methacrylates, unsaturated polyesters, polyvinylformials, phenol-formaldehyde resins, urea-formaldehyde resins, melamine-formaldehyde resins, resorcinol formaldehyde resins polybenzimidazoles; or a mixture of two or more thereof is present.

7. The reaction adhesive of claim 1, characterized in that it comprises curing agents from the group of catalytically active compounds such as peroxides, hydrogen chloride and/or compounds which react in accordance with the polyaddition mechanism and contain amino, hydroxyl, epoxy isocyanate functionalities, carboxylic anhydrides; or a mixture of of two or more of these curing agents.

8. The reaction adhesive of claim 1, characterized in that it comprises at least one additive from the group of plasticizers, stabilizers, antioxidants, dyes, light stabilizers, fillers, dye pigments, fragrances, and preservatives.

9. The reaction adhesive of claim 1, characterized in that the shell of the microcapsule comprises at least one thermoplastic substance from the group of hydrocarbon waxes, wax esters, polyethylene waxes, oxidized hydrocarbon waxes containing hydroxyl or carboxyl groups, polyesters, and polyamides.

10. The reaction adhesive of claim 1, characterized in that the shell of the microcapsule comprises at least one water-soluble or at least water-dispersible polymer from the group of natural and/or synthetic polyanions.

11. The reaction adhesive of at least one of claims 1 to 10, characterized in that the microcapsules have an average particle size of from 0.1 micrometer to 800 micrometers.

12. The reaction adhesive of at least one of claims 1 to 11, characterized in that it comprises microcapsules in an amount of from 0.2 to 20% by weight, based on the overall composition of the reaction adhesive.

13. The reaction adhesive of at least one of claims 1 to 12, characterized in that the concentration of the nanoparticles present as part of the microcapsule is from 0.05 to 20% by weight, based on the total weight of the microcapsule.

14. The reaction adhesive of at least one of claims 1 to 13, characterized in that in addition to nanoparticles at least one further reaction adhesive component is part of the microcapsule and the overall concentration of the reaction adhesive components is from 1 to 90% by weight, based on the overall composition of the microcapsule.

15. The reaction adhesive of at least one of claims 1 to 13, characterized in that the concentration of the nanoparticles present as part of the microcapsule and of at least one curing agent is between 1 to 90% by weight, based on the overall composition of the microcapsule.

16. The reaction adhesive of at least one of claims 1 to 15, comprising:
A) from 50 to 95% by weight of at least one NCO-terminated polyurethane prepolymer,
B) from 0.2 to 20% by weight of microcapsules comprising at least one curing agent I and also nanoparticles having ferromagnetic, ferrimagnetic, superparamagnetic or piezoelectric properties,
C) from 0 to 20% by weight of at least one curing agent II
D) from 0.05 to 30% by weight of additives based on the overall composition of the reaction adhesive, it being possible for curing agent I and curing agent II to be identical or different in chemical nature.

17. The reaction adhesive of claim 16, comprising:
A) at least one NCO-terminated polyester polyurethane,
B) microcapsules comprising at least one curing agent based on an aromatic diamine and also nanoparticles having ferromagnetic, ferrimagnetic, superparamagnetic or piezoelectric properties and
C) at least one curing agent from the group of the polyols.

18. A process for preparing a reaction adhesive of at least one of claims 1 to 17, characterized in that
(I) microcapsules comprising the curing agent and, where appropriate, further reaction adhesive components are mixed with one another with the resin and, where appropriate, further reaction adhesive components directly after preparation or
(II) microcapsules which comprise the curing agent and, where appropriate, further reaction adhesive components are mixed with one another with the resin and, where appropriate, further reaction adhesive components not until immediately before application.

19. The use of a reaction adhesive prepared according to claim 18 for releasing microencapsulated reaction adhesive components, characterized in that the activation of the adhesive following release of at least one microencapsulated reaction adhesive component takes place by exposure to electrical, magnetic and/or electromagnetic alternating fields in combination where appropriate with pressure ultrasound and/or temperature and in the presence of nanoparticles.

20. The use of a reaction adhesive of at least one of claims 1 to 17 as an adhesive for laminating.
